(19) United States
(12) Patent Application Publication
(10) Pub. No.: US 2012/0108221 A1
(43) Pub. Date: May 3, 2012

(54) AUGMENTING COMMUNICATION SESSIONS WITH APPLICATIONS

(75) Inventors: Shawn M. Thomas, Bothell, WA (US); Taqi Jaffri, Seattle, WA (US); Omar Aftab, Kirkland, WA (US)

(73) Assignee: MICROSOFT CORPORATION, Redmond, WA (US)

(21) Appl. No.: 12/914,320

(22) Filed: Oct. 28, 2010

(51) Int. Cl. H04M 3/42; H04M 3/00; G10L 13/00; G06F 17/30

(52) U.S. Cl. 455/415; 707/769; 455/418; 704/260; 707/E17.075; 704/E13.001

(57) ABSTRACT

Embodiments include applications as participants in a communication session such as a voice call. The applications provide functionality to the communication session by performing commands issued by the participants during the communication session to generate output data. Example functionality includes recording audio, playing music, obtaining search results, obtaining calendar data to schedule future meetings, etc. The output data is made available to the participants during the communication session.

### BACKGROUND

Existing mobile computing devices such as smartphones are capable of executing an increasing number of applications. Users visit online marketplaces with their smartphones to download and add applications. The added applications provide capabilities not originally part of the smartphones. Certain functionality of the existing smartphones, however, is not extensible with the added applications. For example, the basic communication functionality such as voice and messaging on the smartphones is generally not affected by the added applications. As such, the communication functionality of the existing systems is unable to benefit from the development and propagation of applications for the smartphones.

### SUMMARY

Embodiments of the disclosure provide access to applications during a communication session. During the communication session, a computing device detects issuance of a command by at least one participant of a plurality of participants in the communication session. The command is associated with an application available for execution by the computing device. The computing device performs the command to generate output data during the communication session. Performing the command includes executing the application. The generated output data is provided by the computing device to the communication session, during the communication session, for access by the plurality of participants during the communication session.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating participants in a communication session.

FIG. 2 is an exemplary block diagram illustrating a computing device having computer-executable components for enabling an application to participate in a communication session.

FIG. 3 is an exemplary flow chart illustrating the inclusion of an application in a communication session upon request by a participant.

FIG. 4 is an exemplary flow chart illustrating the detection and performance of a command by an application included as a participant in the communication session.

FIG. 5 is an exemplary block diagram illustrating participants in an audio communication session interacting with an application executing on a mobile computing device.

FIG. 6 is an exemplary block diagram illustrating a sequence of user interfaces as a user selects music to play during a telephone call.

Corresponding reference characters indicate corresponding parts throughout the drawings.

### DETAILED DESCRIPTION

Referring to the figures, embodiments of the disclosure enable applications 210 to join communication sessions as participants. The applications 210 provide functionality such as recording and transcribing audio, playing audio (e.g., music) during the communication session, identifying and sharing calendar data to help the participants arrange a meeting, or identifying and providing relevant data to the participants.

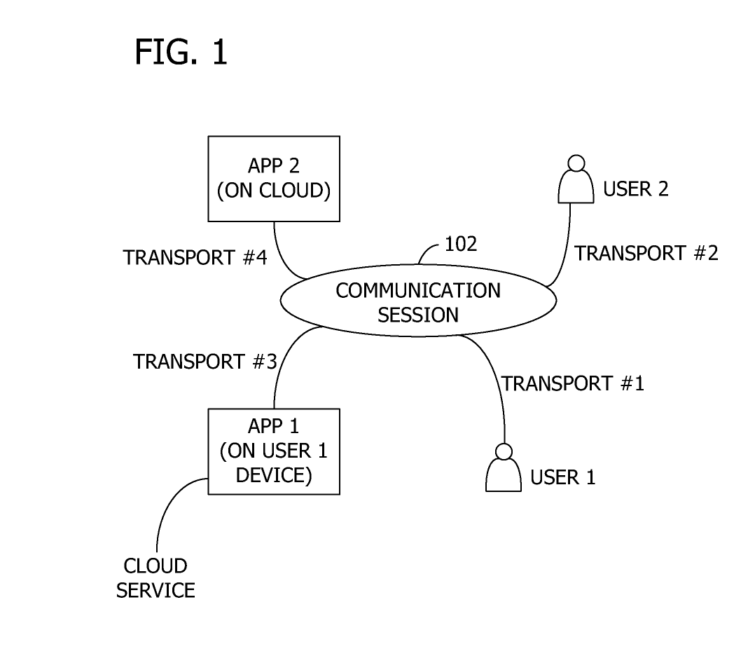

Referring again to FIG. 1, an exemplary block diagram illustrates participants in a communication session. The communication session may include, for example, audio (e.g., a voice call), video (e.g., a video conference or video call), and/or data (e.g., messaging, interactive games). A plurality of the participants exchanges data during the communication session via one or more transports (e.g., transport protocols) or other means for communication and/or participation. In the example of FIG. 1, User 1 communicates via Transport #1, User 2 communicates via Transport #2, App 1 communicates via Transport #3, and App 2 communicates via Transport #4. App 1 and App 2 represent application programs acting as participants in the communication session. In general, one or more applications 210 may be included in the communication session. Each of the applications 210 represents any application executed by a computing device associated with one of the participants such as User 1 or User 2 in the communication session and/or associated with any other computing device. For example, App 1 may execute on a server accessible by a mobile telephone of User 1.

In general, the participants in the communication session may include humans, automated agents, application, or other entities that are communication with each other. Two or more participants may exist on the same computing device or on different devices connected via transports. In some embodiments, one of the participants is the owner of the communication session and may confer rights and functionality to other participants (e.g., ability to share data, invite other participants, etc.).

The transports represent any method or channel of communication (e.g., voice over Internet protocol, voice over a mobile carrier network, short message service, electronic mail messaging, instant messaging, text messaging, and the like). Each of the participants may use any number of transports, as enabled by a mobile carrier or other service provider. In peer-to-peer communication sessions, the transports are peer-to-peer (e.g., a direct channel between two of the participants).

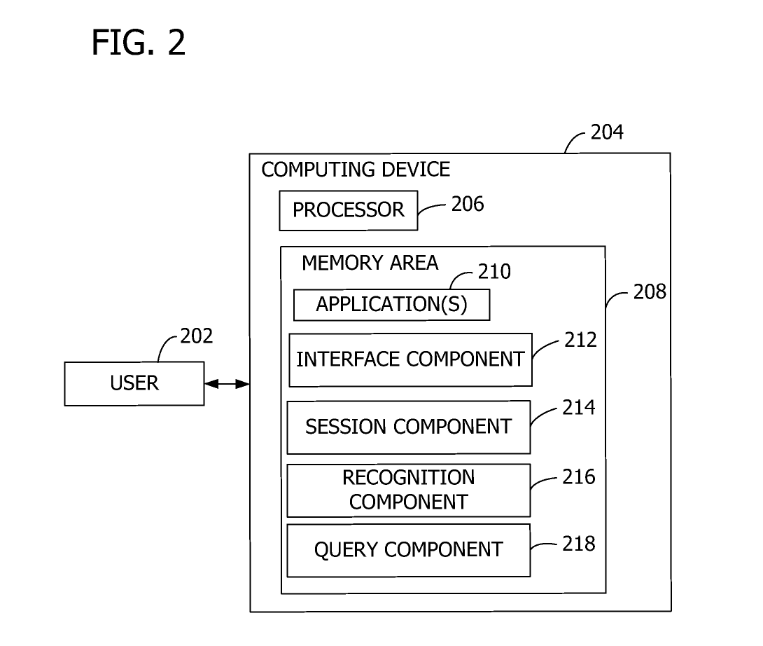

Referring next to FIG. 2, an exemplary block diagram illustrates a computing device 204 having computer-executable components for enabling at least one of the applications 210 to participate in a communication session (e.g., augment the communication session with the application 210). In the example of FIG. 2, the computing device 204 is associated with a user 202. The user 202 represents, for example, User 1 or User 2 from FIG. 1.

The computing device 204 represents any device executing instructions (e.g., as application programs, operating system functionality, or both) to implement the operations and functionality associated with the computing device 204. The computing device 204 may include a mobile computing device 502 or any other portable device. In some embodiments, the mobile computing device 502 includes a mobile telephone, laptop, netbook, gaming device, and/or portable media player. The computing device 204 may also include less portable devices such as desktop personal computers, kiosks, and tabletop devices. Additionally, the computing device 204 may represent a group of processing units or other computing devices.

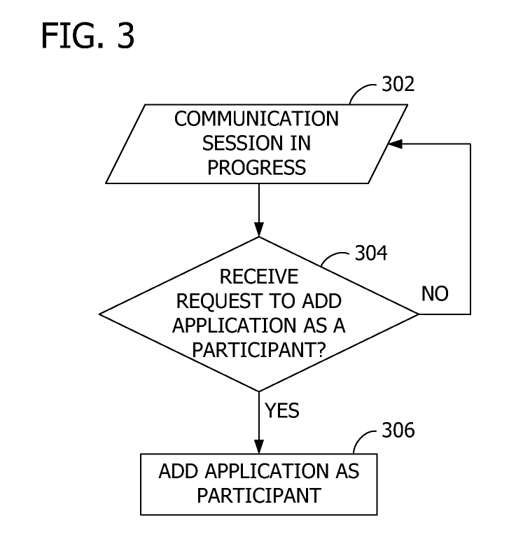

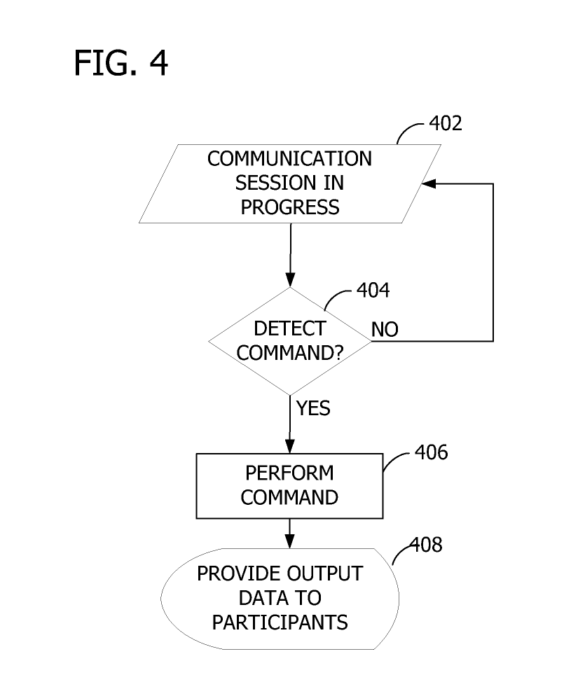

The computing device 204 has at least one processor 206 and a memory area 208. The processor 206 includes any quantity of processing units, and is programmed to execute computer-executable instructions for implementing aspects of the disclosure. The instructions may be performed by the processor 206 or by multiple processors executing within the computing device 204, or performed by a processor external to the computing device 204. In some embodiments, the processor 206 is programmed to execute instructions such as those illustrated in the figures (e.g., FIG. 3 and FIG. 4).

The computing device 204 further has one or more computer-readable media such as the memory area 208. The memory area 208 includes any quantity of media associated with or accessible to the computing device 204. The memory area 208 may be internal to the computing device 204 (as shown in FIG. 2), external to the computing device 204 (not shown), or both (not shown).

The memory area 208 stores, among other data, one or more applications 210 and at least one operating system (not shown). The applications 210, when executed by the processor 206, operate to perform functionality on the computing device 204. Exemplary applications 210 include mail application programs, web browsers, calendar application programs, address book application programs, navigation programs, recording programs (e.g., audio recordings), and the like. The applications 210 may execute on the computing device 204 and communicate with counterpart applications or services such as web services accessible by the computing device 204 via a network. For example, the applications 210 may represent client-side applications that correspond to server-side services such as navigation services, search engines (e.g., Internet search engines), social network services, online storage services, online auctions, network access management, and the like.

The operating system represents any operating system designed to provide at least basic functionality to operate the computing device 204 along with a context or environment in which to execute the applications 210.

In some embodiments, the computing device 204 in FIG. 2 is mobile computing device 502 and the processor 206 is programmed to execute at least one of the applications 210 to provide the user 202 with access to the application 210 (or other applications 210) and participant data during a voice call. The participant data represents calendar data, documents, contacts, etc. of the participant stored by the computing device 204. The participants data may be accessed during the voice call in accordance with embodiments of the disclosure.

The memory area 208 may further store communication session data including one or more of the following: data identifying the plurality of participants in the voice call, data identifying transports used by each of the participants, shared data available to the participants during the communication session, and a description of conversations associated with the communication session. The data identifying the participants may also include properties associated with the participants. Example properties associated with each of the participants include an online status, name, and preferences for sharing data (e.g., during public or private conversations).

The shared data may include, as an example, a voice stream, share documents, a video stream, voting results, etc. The conversations represent one or more private or public sessions involving subsets of the participants. An example communication session may have one public conversation involving all the participants and a plurality of private conversations between smaller groups of participants.

The memory area 208 may also store a speech-to-text conversion application (e.g., a speech recognition program) and a text-to-speech conversion application (e.g., a text recognition program), or both of these applications may be part of a single application. One or more of these applications (or the single application representing both applications) may be participants in the voice call. For example, the speech-to-text conversion application may be included as a participant in the voice call to listen for and recognize pre-defined commands (e.g., a command from the participant to perform a search query, or to play music). Further, the text-to-speech conversion application may be included as a participant in the voice call to provide voice output data to the other participants in the voice call (e.g., read search results, contact data, or appointment availability to the participants). While described in the context of speech-to-text and/or text-to-speech conversion, aspects of the disclosure are operable with other ways to communicate during the communication session such as by tapping an icon.

The memory area 208 further stores one or more computer-executable components. Exemplary components include an interface component 212, a session component 214, a recognition component 216 and a query component 218. The interface component 212, when executed by the processor 206 of the computing device 204, causes the processor 206 to receive a request for at least one of the applications 210 to be included in the communication session. The request is received from at least one of a plurality of participants in the communication session. In the example of a voice call, the participant may speak a pre-defined command or instruction, press a pre-defined one or more buttons, or input a pre-defined gesture (e.g., on a touch screen device) to generate the request.

In general, aspects of the disclosure are operable with any computing device having functionality for providing data for consumption by the user 202 and receiving data input by the user 202. For example, the computing device 204 may provide content for display visually to the user 202 (e.g., via a screen such as a touch screen), audibly (e.g., via a speaker), and/or via touch (e.g., vibrations or other movement from the computing device 204). In another example, the computing device 204 may receive from the user 202 tactile input (e.g., via buttons, an alphanumeric keypad, or a screen such as a touch screen) and/or audio input (e.g., via a microphone). In further embodiments, the user 202 inputs commands or manipulates data by moving the computing device 204 itself in a particular way.

The session component 214, when executed by the processor 206 of the computing device 204, causes the processor 206 to include the application 210 in the communication session in response to the request received by the interface component 212. Once added to the communication session, the application 210 has access to any shared data associated with the communication session.

The recognition component 216, when executed by the processor 206 of the computing device 204, causes the processor 206 to detect a command issued by at least one of the plurality of participants during the communication session. For example, the application 210 included in the communication session is executed by the processor 206 to detect the command. The command may include, for example, search terms. In such an example, the query component 218 executes to perform a query using the search terms to produce search results. The search results include content relevant to the search terms. In some embodiments, the search results include documents accessible by the computing device 204. In such embodiments, the interface component 212 makes the documents available to the participants during the communication session. In an example in which the communication session is a voice-over-Internet-protocol (VoIP) call, the documents may be distributed as shared data among the participants.

The query component 218, when executed by the processor 206 of the computing device 204, causes the processor 206 to perform the command detected by the recognition component 216 to generate output data. For example, the application 210 included in the communication session is executed by the processor 206 to perform the command. The interface component 212 provides the output data generated by the query component 218 to one or more of the participants during the communication session.

In some embodiments, the recognition component 216 and the query component 218 are associated with, or in communication with, the application 210 included in the communication session by the session component 214. In other embodiments, one or more of the interface component 212, the session component 214, the recognition component 216 and the query component 218 are associated with the operating system of the computing device 204 (e.g., a mobile telephone, personal computer, or television).

In embodiments in which the communication session includes audio (e.g., a voice call), the recognition component 216 executes to detect a pre-defined voice command spoken by at least one of the participants during the communication session. The query component 218 executes to perform the detected command. Performing the command generates voice output data, which the interface component 212 plays or renders to the participants during the communication session.

A plurality of applications 210 may act as participants in the communication session, in some embodiments. For example, one application (e.g., a first application) included in the communication session detects the pre-defined command, and another application (e.g., a second application) included in the communication session executes to perform the detected, pre-defined command to generate output data, and/or to provide the output data to the participants. In such an example, the first application communicates with the second application to have the second application generate the voice output data (e.g., if the communication session includes audio).

Further, one or more of the plurality of applications 210 acting as participants in the communication session may by executed by a processor other than the processor 206 associated with the computing device 204. As an example, two human participants can each include an application available on their respective computing devices in the communication session. For example, one application may record the audio from the communication session, while the other application generates an audio reminder when a pre-defined duration elapses (e.g., the communication session exceeds a designated duration).

Referring next to FIG. 3, an exemplary flow chart illustrates the inclusion of one of the applications 210 in a communication session upon request by a participant. At 302, the communication session is in progress. For example, one participant calls another participant. If a request is received at 304 to add one of the available applications 210 as a participant, the application 210 is added as a participant at 306.

The available applications 210 include those applications that have identified themselves to an operating system on the computing device 204 as capable of being included in the communication session. For example, metadata provided by the developer of the application 210 may indicate that the application 210 is available for inclusion in communication sessions.

Adding the application 210 as a participant includes enabling the application 210 to access communication data (e.g., voice data) and shared data associated with the communication session.

In some embodiments, an operating system associated with a computing device of one of the participants defines and propagates the communication session data describing the communication session to each of the participants. In other embodiments, each of the participants defines and maintains their own description of the communication session. The communication session data includes, for example, shared data and/or data describing conversations occurring within the communication session. For example, if there are four participants, there may be two conversations occurring during the communication session.

Referring next to FIG. 4, an exemplary flow chart illustrates the detection and performance of a command by one of the applications 210 included as a participant in the communication session. At 402, the communication session is in progress and the application 210 has been included in the communication session (e.g., see FIG. 3). During the communication session, a pre-defined command may be issued by one of the participants. The pre-defined command is associated with the application 210. Issuing the command may include the participant speaking a voice command, entering a written or typed command, and/or gesturing a command.

When the issued command is detected at 404 by the application 210, the command is performed by the application 210 at 406. Performing the command includes, but is not limited to, executing a search query, obtaining calendar data, obtaining contact data, or obtaining messaging data. Performance of the command generates output data that is provided during the communication session to the participants at 408. For example, the output data may be voiced to the participants, displayed on computing devices of the participants, or otherwise shared with the participants.

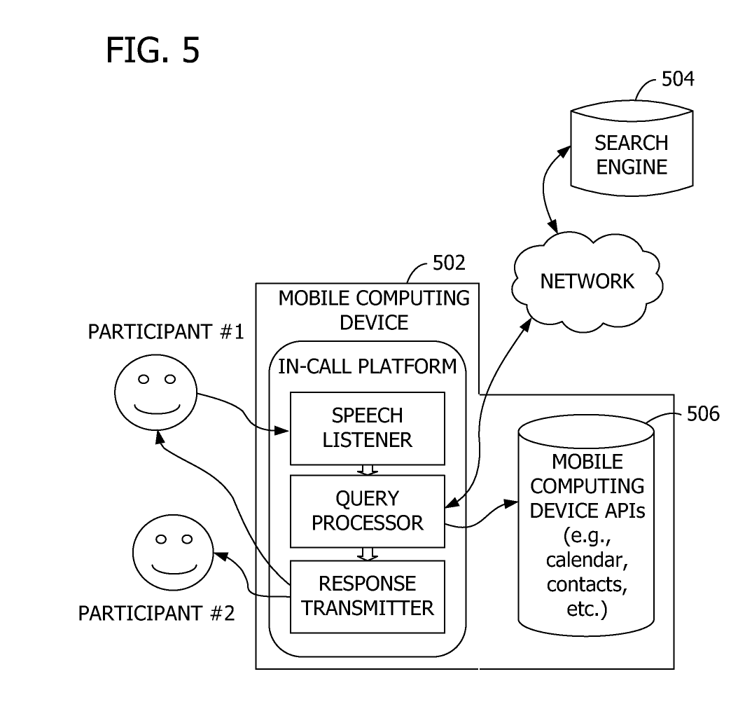

Referring next to FIG. 5, an exemplary block diagram illustrates participants in an audio communication session interacting with one of the applications 210 executing on mobile computing device 502. The mobile computing device 502 includes an in-call platform having a speech listener, a query processor, and a response transmitter. The speech listener, query processor, and response transmitter may be computer-executable components or other instructions. The in-call platform executes at least while the communication session is active. In the example of FIG. 5, Participant #1 and Participant #2 are the participants in the communication session, similar to User 1 and User 2 shown in FIG. 1. Participant #1 issues a pre-defined command (e.g., speaks, types, or gestures the command). The speech listener detects the command and passes the command to the query processor (or otherwise activates or enables the query processor). The query processor performs the command to produce output data. For example, the query processor may communicate with a search engine 504 (e.g., an off-device resource) via a network to generate search results or other output data. Alternatively or in addition, the query processor may obtain and/or search calendar data, contact data, and other on-device resources via one or more mobile computing device application programming interfaces (APIs) 506. The output data resulting from performance of the detected command is passed by the query processor to the response transmitter. The response transmitter shares the output data with Participant #1 and Participant #2.

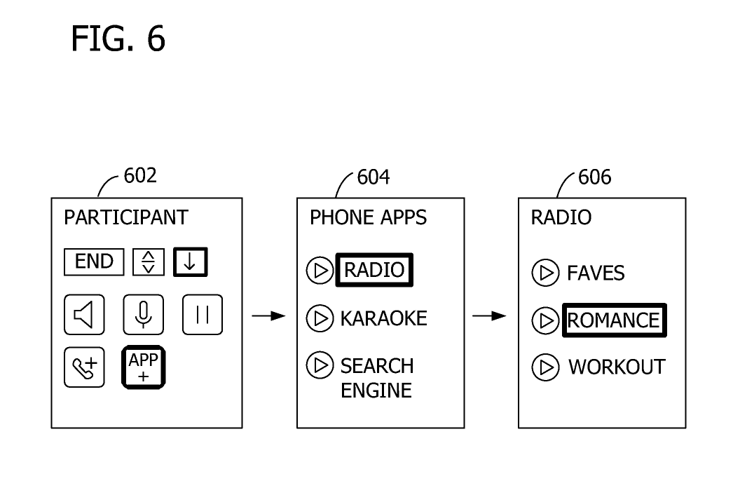

Referring next to FIG. 6, an exemplary block diagram illustrates a sequence of user interfaces as a participant selects music to play during a telephone call. The user interfaces may be displayed by the mobile computing device 502 during an audio communication session (e.g., a voice call) between two or more participants. One of the participants may include a music application in the communication session. The participants may then issue commands via speech, keypad, or touch screen entry to use the application and play music to the participants during the communication session.

At 602 in the example of FIG. 6, one of the participants chooses to display a list of available applications (e.g., selects the bolded App+icon). At 604, the list of available applications is displayed to the participant. The participant selects the radio application (as indicated by the bolded line around “radio”) and then chooses a genre of music at 606 to play to the participants during the communication session. In the example of FIG. 6, the participant selects the “romance” genre and the box surrounding the “romance” genre is bolded.

Communication sessions involving one human participant are contemplated. For example, the human participant may be on hold (e.g., with a bank or customer service) and decides to play his or her own selection of music to pass the time.

### Additional Examples

Further examples are next described. In a communication session having an audio element (e.g., a voice call), detecting the command issued by at least one of the participants includes receiving a request to record audio data associated with the voice call. The recorded audio data may be provided to the participants later during the call or transcribed and provided to the participants as a text document.

In some embodiments, the participants orally ask for movie or restaurant suggestions. The questions are detected by a search engine application acting as a participant according to the disclosure, and the search engine application orally provides the recommendations to the participants. In a further example, the recommendations appear on the screens of the mobile telephones of the participants.

In another embodiment, one of the applications 210 according to the disclosure listens to a voice call and surfaces or otherwise provides relevant documents to the participants. For example, the documents may be identified as relevant based on keywords spoken during the voice call, the names of the participants, the location of the participants, etc.

In another embodiments, applications 210 acting as participants in a communication session may offer: sound effects and/or voice-altering operations, alarms or stopwatch functionality to send or speak a reminder when a duration of time has elapsed, and music to be selected by the participants and played during the communication session.

Aspects of the disclosure further contemplate enabling mobile carriers or other communication service providers to provide and/or monetize the applications 210. For example, the mobile carriers may charge the requesting participant a fee to include the application 210 as a participant in the communication sessions. In some embodiments, a monthly fee or a per-use fee may apply.

In embodiments in which the communication session is a video call, an application 210 acting as a participant in a video call may alter the video upon request by the user 202. For example, if the user 202 is at the beach, the application 210 may change the background behind the user 202 to an office setting.

At least a portion of the functionality of the various elements in FIG. 2 may be performed by other elements in FIG. 2, or an entity (e.g., processor, web service, server, application program, computing device, etc.) not shown in FIG. 2.

The operations illustrated in FIG. 3 and FIG. 4 may be implemented as software instructions encoded on a computer-readable medium, in hardware programmed or designed to perform the operations, or both.

While embodiments have been described with reference to data collected from participants, aspects of the disclosure may provide notice to the participants of the collection of the data (e.g., via a dialog box or preference setting) and the opportunity to give or deny consent. The consent may take the form of opt-in consent or opt-out consent.

For example, the participants may opt to not participate in any communication sessions in which applications 210 may be added as participants.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for providing data stored in the memory area 208 to the participants during the voice call, and exemplary means for including one or more of the plurality of applications 210 as participants in the voice call.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for providing access to applications during a voice call, said system comprising:
a memory area associated with a mobile computing device, said memory area storing participant data and a plurality of applications; and
a processor programmed to execute at least one of the applications to:
detect a pre-defined voice command spoken by at least one of a plurality of participants during a voice call;
perform the detected, pre-defined voice command to generate voice output data from the participant data stored in the memory area; and
play the generated voice output data for the participants during the voice call.

2. The system of claim 1, wherein the memory area further stores communication session data including one or more of the following: data identifying the plurality of participants in the voice call and data identifying transports used by each of the participants.

3. The system of claim 1, wherein the memory area further stores a text-to-speech conversion application, and wherein the processor is programmed to generate the voice output data by executing the text-to-speech conversion application.

4. The system of claim 1, wherein the at least one of the applications represents a first application, and wherein the processor is programmed to perform the detected, pre-defined voice command by executing a second application, wherein the first application communicates with the second application to generate the voice output data.

5. The system of claim 1, wherein the processor is programmed to perform the detected, pre-defined voice command by communicating with an application executing on a computing device accessible to the mobile computing device by a network.

6. The system of claim 1, further comprising means for providing data stored in the memory area to the participants during the voice call.

7. The system of claim 1, further comprising means for including one or more of the plurality of applications as participants in the voice call.

8. A method comprising:
detecting, by a computing device during a communication session, issuance of a command by at least one participant of a plurality of participants in the communication session, wherein the command is associated with an application available for execution by the computing device;
performing, by the computing device, the command to generate output data during the communication session, wherein performing the command includes executing the application; and
providing, by the computing device during the communication session, the generated output data to the communication session for access by the plurality of participants during the communication session.

9. The method of claim 8, wherein detecting the issuance of the command comprises one or more of the following: detecting a voice command spoken by the participant during a voice communication session, detecting a written command typed by the participant during a messaging communication session, and detecting a gesture entered by the participant.

10. The method of claim 8, wherein detecting issuance of the command comprises detecting issuance of a command to perform one or more of the following: record and transcribe audio, play audio during the communication session, and identify and share calendar data to help the participants arrange a meeting.

11. The method of claim 8, wherein performing the command comprises one or more of the following: executing a search query, obtaining calendar data, obtaining contact data, and obtaining messaging data.

12. The method of claim 8, further comprising defining communication session data including shared data and/or data describing conversations.

13. The method of claim 8, wherein the communication session comprises a voice call, wherein detecting issuance of the command comprises receiving a request to record audio data associated with the voice call, and wherein providing the generated output data comprises providing the recorded audio data to the participants upon request during the voice call.

14. The method of claim 13, further comprising transcribing the recorded audio data and providing the transcribed audio data to the participants.

15. The method of claim 8, wherein detecting issuance of the command comprises receiving a request to play music during a voice call.

16. The method of claim 8, wherein providing the generated output data comprises providing the generated output data for display on computing devices associated with the participants.

17. One or more computer-readable media having computer-executable components, said components comprising:
an interface component that when executed by at least one processor of a computing device causes the at least one processor to receive a request, from at least one of a plurality of participants in a communication session, for an application to be included in the communication session;
a session component that when executed by at least one processor of the computing device causes the at least one processor to include the application in the communication session in response to the request received by the interface component;
a recognition component that when executed by at least one processor of the computing device causes the at least one processor to detect a command issued by at least one of the plurality of participants during the communication session; and
a query component that when executed by at least one processor of the computing device causes the at least one processor to perform the command detected by the recognition component to generate output data,
wherein the interface component provides the output data generated by the query component to one or more of the plurality of participants during the communication session, and wherein the recognition component and the query component are associated with the application included in the communication session by the session component.

18. The computer-readable media of claim 17, wherein the recognition component comprises a text recognition application and/or a speech recognition application.

19. The computer-readable media of claim 17, wherein the command includes search terms, wherein the query component executes to perform a query using the search terms, wherein performing the query produces search results, wherein the search results include documents accessible by the computing device, and wherein the interface component provides at least one of the documents to the participants during the communication session.

20. The computer-readable media of claim 19, wherein the communication session comprises a video call.
